(19) United States
(12) Patent Application Publication
(10) Pub. No.: US 2026/0195894 A1
(43) Pub. Date: Jul. 9, 2026

(54) INTERPRETATION METHOD FOR PARASITE CYST AND INTERPRETATION SYSTEM FOR PARASITE CYST

(71) Applicants: NATIONAL TSING HUA UNIVERSITY, HSINCHU (TW); Kaohsiung Municipal Siaogang Hospital, Kaohsiung City (TW)

(72) Inventors: Chih-Chiang TSAI, HSINCHU (TW); Chih-Hsing HUNG, Kaohsiung City (TW); Chia-Chieh CHU, HSINCHU (TW)

(21) Appl. No.: 19/442,961

(22) Filed: Jan. 7, 2026

(30) Foreign Application Priority Data
Jan. 9, 2025 (TW) 114100975

(51) Int. Cl. G06T 7/00; G06T 7/62; G06V 10/26; G06V 10/40; G06V 10/764; G06V 10/82; G06V 20/69

(52) U.S. Cl. CPC G06T 7/0012; G06T 7/62; G06V 10/26; G06V 10/40; G06V 10/764; G06V 10/82; G06V 20/695; G06V 20/698; G06T 2207/20081; G06T 2207/20084; G06T 2207/30024

(57) ABSTRACT

An interpretation method for a parasite cyst and an interpretation system for the parasite cyst are proposed. The interpretation method includes photographing a parasite specimen to generate an electronic image; cutting the electronic image to generate a plurality of parasite cyst images, and obtaining parasite cyst information on each of the parasite cyst images; extracting at least one biological feature from each of the parasite cyst images by a deep learning model, and classifying the at least one biological feature into at least one of a plurality of feature categories; and performing a cross-comparison on the parasite cyst images having the same feature category according to the parasite cyst information and the feature categories, thereby generating a parasite cyst interpretation result for each of the parasite cyst images.

### RELATED APPLICATIONS

This application claims priority to Taiwan Application Serial Number 114100975, filed Jan. 9, 2025, which is herein incorporated by reference.

### BACKGROUND

### Technical Field

The present disclosure relates to an image recognition method and an image recognition system. More particularly, the present disclosure relates to an interpretation method for a parasite cyst and an interpretation system for the parasite cyst.

### Description of Related Art

Intestinal parasites are prevalent in tropical and subtropical regions, particularly in developing or underdeveloped countries in Southeast Asia, South Asia, Africa, and Central and South America. Due to the climate and sanitary conditions in these regions, combined with poverty and a lack of medical resources, the incidence of intestinal parasitic diseases remains high. Medical institutions need to conduct a large number of intestinal parasite tests as part of their routine operations, especially in areas with high demand for foreign migrant workers.

However, the diagnosis and treatment of intestinal parasitic diseases face multiple challenges, such as diverse transmission routes, a high proportion of asymptomatic infections, limitations of existing diagnostic methods, low detection rates, and poor consistency. These issues have become even more prominent in the context of increasing global interactions. In addition, due to the excessive number of microscopic slides examined by medical technician, eye fatigue is common, leading not only to prolonged recognition times for parasite cysts but also to a higher rate of human labeling errors. Accordingly, there is currently a lack of a low-cost and efficient detection solution for parasite cysts in the market, prompting relevant industries to seek viable solutions.

### SUMMARY

According to one aspect of the present disclosure, an interpretation method for a parasite cyst includes a plurality of steps of: photographing, by an electronic equipment, a parasite specimen to generate an electronic image; cutting, by a processor, the electronic image to generate a plurality of parasite cyst images, and obtaining a parasite cyst information on each of the parasite cyst images; extracting, by the processor, at least one biological feature from each of the parasite cyst images by a deep learning model, and classifying the at least one biological feature into at least one of a plurality of feature categories; and performing, by the processor, a cross-comparison on the parasite cyst images having at least one same feature category according to the parasite cyst information and the feature categories, thereby generating a parasite cyst interpretation result for each of the parasite cyst images, wherein the feature categories comprise the at least one same feature category.

According to another aspect of the present disclosure, an interpretation system for a parasite cyst includes an electronic equipment, a storage device, and a processor. The electronic equipment is configured to photograph a parasite specimen to generate an electronic image. The storage device is connected to the electronic equipment and stores the electronic image and a deep learning model. The processor is connected to the storage device and configured to perform following steps: cutting, by the processor, the electronic image to generate a plurality of parasite cyst images, and obtaining a parasite cyst information on each of the parasite cyst images; extracting, by the processor, at least one biological feature from each of the parasite cyst images by the deep learning model, and classifying the at least one biological feature into at least one of a plurality of feature categories; and performing, by the processor, a cross-comparison on the parasite cyst images having at least one same feature category according to the parasite cyst information and the feature categories, thereby generating a parasite cyst interpretation result for each of the parasite cyst images, wherein the feature categories comprise the at least one same feature category.

### BRIEF DESCRIPTION OF THE DRAWINGS

The present disclosure can be more fully understood by reading the following detailed description of the embodiment, with reference made to the accompanying drawings as follows:

FIG. 1 is a block diagram illustrating an interpretation system for a parasite cyst according to a first embodiment of the present disclosure.

FIG. 2 is a flowchart illustrating an interpretation method for a parasite cyst according to a second embodiment of the present disclosure.

FIG. 3 is a schematic diagram illustrating the generation of a plurality of parasite cyst interpretation results according to an embodiment of the present disclosure.

FIG. 4 is a schematic diagram illustrating an electronic image according to an embodiment of the present disclosure.

FIG. 5 is a flowchart illustrating the step of obtaining parasite cyst information on each of the parasite cyst images in the interpretation method for the parasite cyst shown in FIG. 2.

FIG. 6 is a schematic diagram illustrating a parasite cyst image of an Entamoeba coli cyst according to an embodiment of the present disclosure.

FIG. 7 is a schematic diagram illustrating a parasite cyst image of a Giardia lamblia cyst according to an embodiment of the present disclosure.

FIG. 8 is a schematic diagram illustrating a parasite cyst image of an Endolimax nana cyst according to an embodiment of the present disclosure.

FIG. 9 is a schematic diagram illustrating parasite cyst images of an Entamoeba hartmanni cyst and an Entamoeba histolytica cyst according to an embodiment of the present disclosure.

FIG. 10 is a schematic diagram illustrating parasite cyst images of an Entamoeba histolytica cyst and an Entamoeba hartmanni cyst according to another embodiment of the present disclosure.

FIG. 11 is a schematic diagram illustrating a parasite cyst image of a Blastocystis species cyst according to an embodiment of the present disclosure.

FIG. 12 is a schematic diagram illustrating parasite cyst images of an Iodamoeba butschlii cyst and a Blastocystis species cyst according to an embodiment of the present disclosure.

FIG. 13 is a schematic diagram illustrating parasite cyst images of an Iodamoeba butschlii cyst and an Endolimax nana cyst according to an embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected” to another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

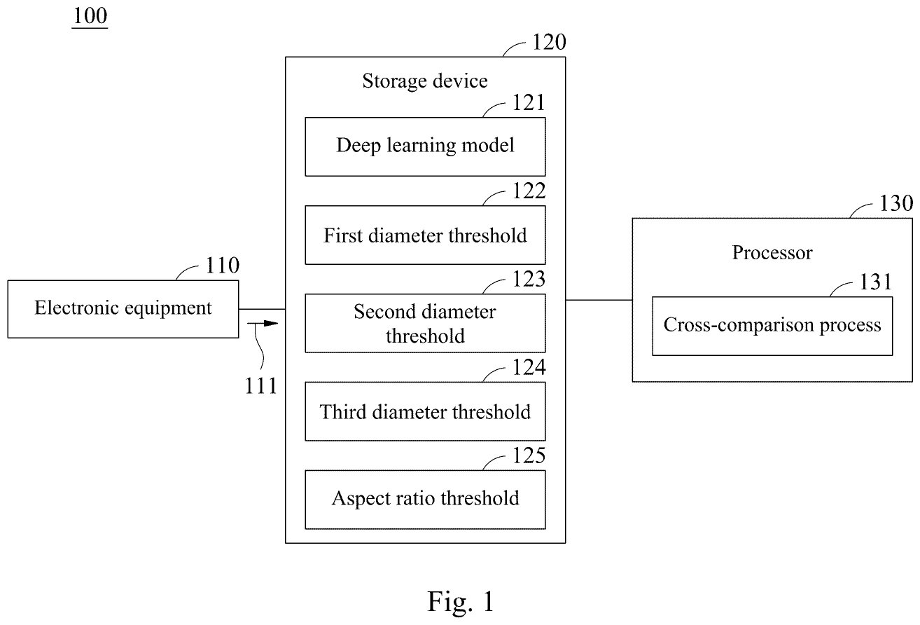

Please refer to FIG. 1. FIG. 1 is a block diagram illustrating an interpretation system 100 for a parasite cyst according to a first embodiment of the present disclosure. As shown in FIG. 1, the interpretation system 100 for the parasite cyst (hereinafter, referred to as “the interpretation system 100”) includes an electronic equipment 110, a storage device 120, and a processor 130.

The electronic equipment 110 is configured to photograph a parasite specimen (not shown) to generate an electronic image 111. In some embodiments, the parasite specimen can be, for example, a slide or a culture dish containing aggregated parasite cysts, but the present disclosure is not limited thereto. The electronic equipment 110 can be, but is not limited to, an electron microscope, which captures images of the parasite specimen at a high magnification (e.g., 100× magnification) to generate the electronic image 111, and stores the electronic image 111 in the storage device 120.

The storage device 120 is electrically connected to the electronic equipment 110 and stores a deep learning model 121, a first diameter threshold 122, a second diameter threshold 123, a third diameter threshold 124, and an aspect ratio threshold 125. In some embodiments, the storage device 120 can be a machine-readable medium. The machine-readable medium can be, but is not limited to, a Random Access Memory (RAM), a Read-Only Memory (ROM), a Compact Disc Read-Only Memory (CD-ROM), a flash memory, a hard disk drive, a magnetic tape, a floppy disk, or an optical data storage device, and can further store a plurality of codes or software modules.

The processor 130 is electrically connected to the storage device 120 and configured to access the deep learning model 121, the first diameter threshold 122, the second diameter threshold 123, the aspect ratio threshold 125, and a plurality of codes, software modules, or instructions to automatically perform an interpretation method for a parasite cyst proposed in the present disclosure, thereby labeling a plurality of parasite cyst interpretation results in the electronic image 111. In some embodiments, the processor 130 can be, but is not limited to, a Digital Signal Processor (DSP), a Micro Processing Unit (MPU), a Central Processing Unit (CPU), a Graphics Processing Unit (GPU), or another electronic processor. In other embodiments, the storage device 120 and the processor 130 can be internal components of an electronic device, which can be, but is not limited to, various types of computer devices, smart devices, server devices, or combinations thereof.

Therefore, the interpretation system 100 of the present disclosure is capable of automatically identifying the species of parasite cysts in the electronic image 111 and labeling the parasite cyst interpretation results, thereby significantly reducing the interpretation time of medical technician and minimizing human errors, which enhances the detection rate and accuracy of parasite cysts. In addition, the high efficiency and automation of the interpretation system 100 can greatly reduce labor costs in medical institutions and help suppress the spread and prevalence of parasitic diseases. The interpretation system 100 can also be applied to the interpretation of various species of parasite cysts and provides consistency in interpretation standards. The following paragraphs will describe in detail steps of the interpretation method for the parasite cyst of the present disclosure with reference to the accompanying drawings.

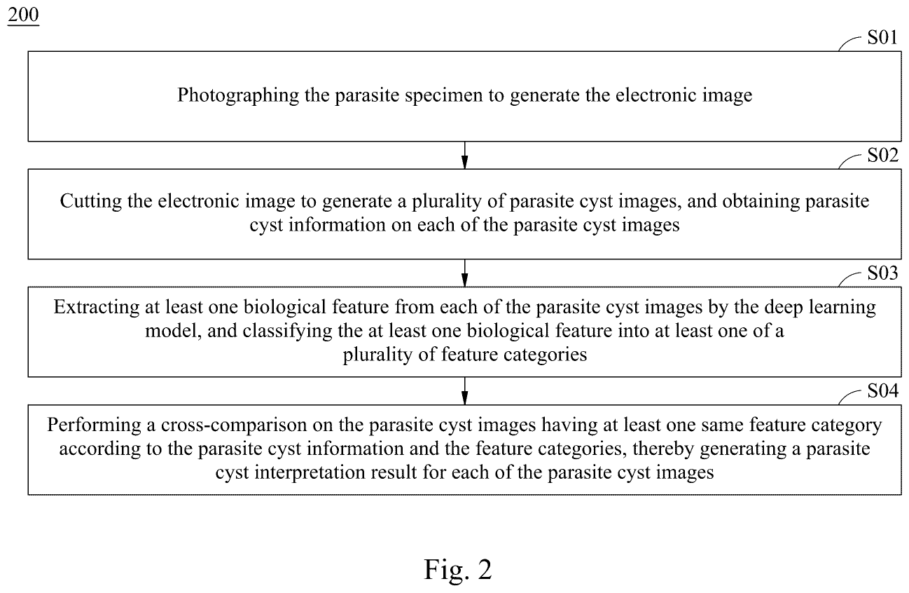

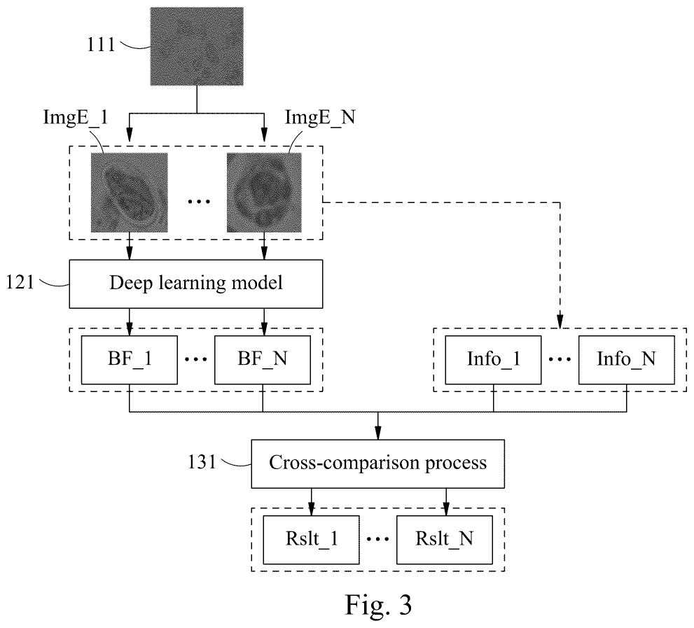

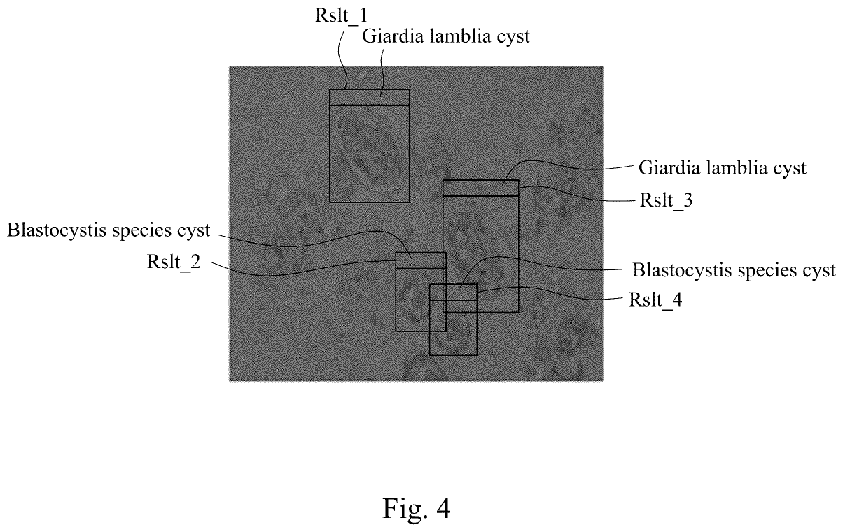

Please refer to FIGS. 1, 2, 3 and 4. FIG. 2 is a flowchart illustrating an interpretation method 200 for a parasite cyst according to a second embodiment of the present disclosure. FIG. 3 is a schematic diagram illustrating the generation of a plurality of parasite cyst interpretation results Rslt_1-Rslt_N according to an embodiment of the present disclosure. FIG. 4 is a schematic diagram illustrating the electronic image 111 according to an embodiment of the present disclosure. As shown in FIGS. 1, 2 and 3, the interpretation method 200 for the parasite cyst (hereinafter, referred to as “the interpretation method 200”) can be automatically executed by the interpretation system 100 and includes the following Steps S01, S02, S03, S04.

Step S01 involves photographing, by the electronic equipment 110, the parasite specimen to generate the electronic image 111.

Step S02 involves cutting, by the processor 130, the electronic image 111 to generate a plurality of parasite cyst images ImgE_1-ImgE_N, and obtaining parasite cyst information on each of the parasite cyst images ImgE_1-ImgE_N. The parasite cyst images ImgE_1-ImgE_N respectively have corresponding parasite cyst information Info_1-Info_N.

Step S03 involves extracting, by the processor 130, at least one biological feature from each of the parasite cyst images ImgE_1-ImgE_N by the deep learning model 121, and classifying the at least one biological feature into at least one of a plurality of feature categories. Specifically, in Step S03, the processor 130 inputs the parasite cyst image ImgE_1 into the deep learning model 121 and performs an object detection on the parasite cyst image ImgE_1 through the deep learning model 121 to extract a biological feature BF_1. The processor 130 can further frame the position of the biological feature BF_1 within the parasite cyst image ImgE_1. Similarly, the processor 130 extracts a biological features BF_N from the parasite cyst image ImgE_N through the deep learning model 121, and the number of each of the biological features BF_1-BF_N can be at least one.

Step S04 involves performing, by the processor 130, a cross-comparison on the parasite cyst images ImgE_1-ImgE_N having at least one same feature category according to the parasite cyst information Info_1-Info_N and the feature categories, thereby generating a parasite cyst interpretation result for each of the parasite cyst images ImgE_1-ImgE_N, wherein the feature categories include the at least one same feature category. Specifically, in Step S04, the processor 130 performs a cross-comparison process 131 on the parasite cyst images ImgE_1-ImgE_N that share the same feature category. In the cross-comparison process 131, the processor 130 not only identifies the species of parasite cysts corresponding to the parasite cyst images ImgE_1-ImgE_N based on the feature categories of the biological features BF_1-BF_N, but also further analyzes the parasite cyst information of the parasite cyst images having the same feature category. Thus, the parasite cyst information and the feature categories are jointly used for comprehensive determination of the species of parasite cysts, thereby generating a plurality of parasite cyst interpretation results Rslt_1-Rslt_N corresponding to the parasite cyst images ImgE_1-ImgE_N.

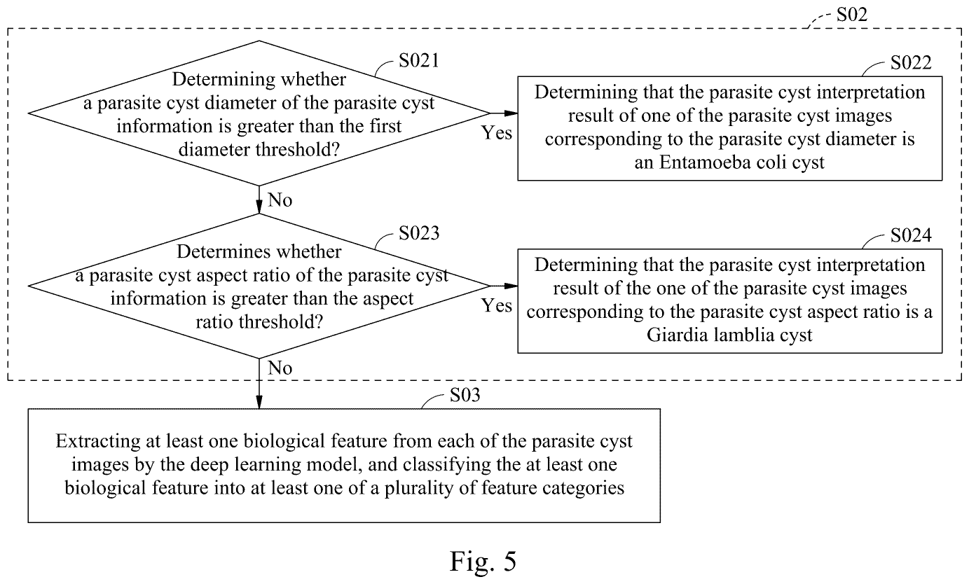

As shown in FIG. 4, after the processor 130 is configured to perform the interpretation method 200, it can label the parasite cyst interpretation results Rslt_1, Rslt_2, Rslt_3, Rslt_4 in the electronic image 111. The parasite cyst interpretation results Rslt_1, Rslt_2, Rslt_3, Rslt_4 respectively indicate the corresponding species of parasite cysts, such as a Giardia lamblia cyst and a Blastocystis Species cyst shown in FIG. 4, but the present disclosure is not limited thereto. Therefore, medical technician can view the parasite cyst interpretation results Rslt_1, Rslt_2, Rslt_3, Rslt_4 in the electronic image 111 of FIG. 4 to quickly identify the species of parasite cysts present in the parasite specimen, thereby shortening manual interpretation time and improving testing efficiency. In particular, the interpretation method 200 of the present disclosure does not rely solely on the biological features BF_1-BF_N obtained by the deep learning model 121 as the only basis for determining the parasite cyst species; rather, by incorporating the parasite cyst information Info_1-Info_N and performing cross-analysis on multiple feature categories, the accuracy of parasite cyst recognition is improved. To facilitate understanding of the operations in Steps S02, S03, S04, detailed explanations will be provided below with reference to FIGS. 5 to 13.

It should first be noted that common cysts of intestinal parasites (i.e., parasite cysts) include seven species. Based on the atlas of human intestinal parasites, the microscopic morphology characteristics of these seven species of parasite cysts are as follows, but the present disclosure is not limited thereto.

Species 1: Entamoeba histolytica cyst—generally spherical in shape, commonly 12 μm to 15 μm in diameter, typically containing 1 to 4 nuclei. The karyosome chromatin is small and usually centrally located. The parasite cyst size is slightly larger than that of Entamoeba hartmanni cyst.

Species 2: Entamoeba hartmanni cyst—generally round in shape, commonly 6 μm to 8 μm in diameter, typically containing 1 to 4 nuclei. The karyosome chromatin is small and usually centrally located. The parasite cyst size is slightly smaller than that of Entamoeba histolytica cyst.

Species 3: Endolimax nana cyst—round or elongated oval in shape, commonly 6 μm to 8 μm in diameter, generally containing 1 to 4 irregular, dot-like karyosome chromatin structures, and lacking peripheral chromatin.

Species 4: Entamoeba coli cyst—typically round in shape, commonly 15 μm to 25 μm in diameter, the largest among the seven species of parasite cysts. Entamoeba coli cyst usually contains 8 nuclei, and the karyosome chromatin is relatively large.

Species 5: Iodamoeba butschlii cyst—round or oval in shape, commonly 10 μm to 12 μm in diameter, containing a single large karyosome chromatin and lacking peripheral chromatin. A glycogen vacuole is present within the parasite cyst, occupying most of the cyst body and compressing the nucleus to one side.

Species 6: Giardia lamblia cyst—elongated oval in shape with a long major axis, and the interior appears dark and uniform in color.

Species 7: Blastocystis species cyst (i.e., Blastocystis sp. cyst)—containing a large vacuole with a highly transparent appearance, and the nuclei are compressed toward the periphery by the vacuole.

In the present disclosure, the term “parasite cyst” is used broadly to refer to the resting or dormant stage of a parasite. This includes, but is not limited to, protozoan cysts (e.g., Entamoeba, Giardia), oocysts (e.g., Cryptosporidium), and other similar biological structures derived from parasites.

Specifically, in Step S02, the processor 130 reads the electronic image 111 from the storage device 120, performs image preprocessing and binarization, and then conducts image segmentation on the electronic image 111 based on individual cysts to obtain the parasite cyst images ImgE_1-ImgE_N. The processor 130 then analyzes the parasite cyst images ImgE_1-ImgE_N to record the corresponding parasite cyst information Info_1-Info_N.

Each of the parasite cyst information Info_1-Info_N can include at least one of a parasite cyst diameter, a parasite cyst aspect ratio, and a parasite cyst contour. The parasite cyst contour can, for example, be approximately circular or approximately elliptical. In some embodiments, the processor 130 determines whether the shape of the parasite cyst in each of the parasite cyst images ImgE_1-ImgE_N is approximately circular or approximately elliptical based on its parasite cyst contour. If the parasite cyst contour is approximately circular, the processor 130 records the corresponding cyst diameter; if the parasite cyst contour is approximately elliptical, the processor 130 records the corresponding parasite cyst aspect ratio. In other embodiments, each of the parasite cyst information Info_1-Info_N can further include the image size of the parasite cyst, which can be defined as the length of the longer side of the minimum rectangle that encloses each of the parasite cyst images ImgE_1-ImgE_N.

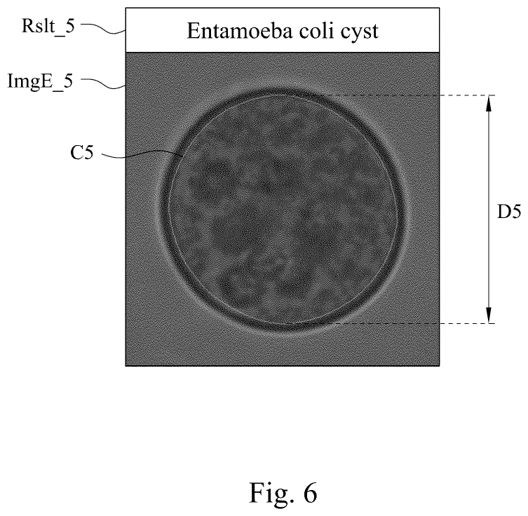

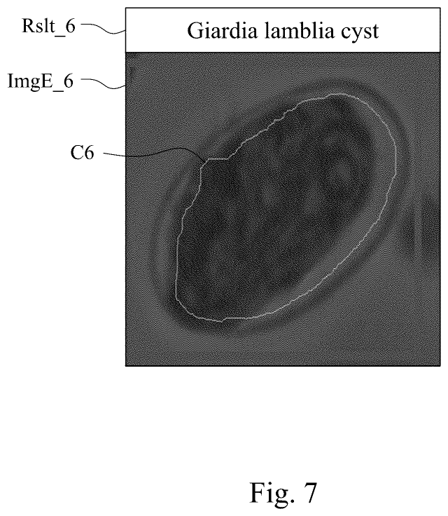

Please refer to FIGS. 5, 6 and 7. FIG. 5 is a flowchart illustrating Step 02 of obtaining parasite cyst information on each of the parasite cyst images ImgE_1-ImgE_N in the interpretation method 200 shown in FIG. 2. FIG. 6 is a schematic diagram illustrating the parasite cyst image ImgE_5 of the Entamoeba coli cyst according to an embodiment of the present disclosure. FIG. 7 is a schematic diagram illustrating the parasite cyst image ImgE_6 of the Giardia lamblia cyst according to an embodiment of the present disclosure.

As shown in FIG. 5, Step S02 can include Steps S021, S022, S023, S024. Step S021 involves, by the processor 130, determining whether a parasite cyst diameter of the parasite cyst information is greater than the first diameter threshold 122 to generate a determination result. When the determination result is “Yes”, the processor 130 performs Step S022. Step S022 involves, by the processor 130, determining that the parasite cyst interpretation result of one of the parasite cyst images ImgE_1-ImgE_N corresponding to the parasite cyst diameter (which is greater than the first diameter threshold 122) is an Entamoeba coli cyst. Conversely, when the determination result is “No”, the processor 130 determines that the parasite cyst interpretation result of the one of the parasite cyst images ImgE_1-ImgE_N corresponding to the parasite cyst diameter (which is less than the first diameter threshold 122) is not the Entamoeba coli cyst, and subsequently performs Step S023.

Step S023 involves, by the processor 130, determining whether a parasite cyst aspect ratio of the parasite cyst information is greater than the aspect ratio threshold 125 to generate a determination result. When the determination result is “Yes”, the processor 130 performs Step S024. Step S024 involves, by the processor 130, determining that the parasite cyst interpretation result of the one of the parasite cyst images ImgE_1-ImgE_N corresponding to the parasite cyst aspect ratio (which is greater than the aspect ratio threshold 125) is a Giardia lamblia cyst. Conversely, when the determination result is “No”, the processor 130 determines that the parasite cyst interpretation result of the one of the parasite cyst images ImgE_1-ImgE_N corresponding to the parasite cyst aspect ratio (which is less than the aspect ratio threshold 125) is not the Giardia lamblia cyst, and subsequently performs the aforementioned Step S03.

The first diameter threshold 122 can be, but is not limited to, 15 μm, and the aspect ratio threshold 125 can be, but is not limited to, 1.36. As shown in FIG. 6, with respect to the parasite cyst image ImgE_5, a parasite cyst contour C5 of the parasite cyst information Info_5 is approximately circular, so the processor 130 records the corresponding parasite cyst diameter D5. In Step S021, the processor 130 determines that the parasite cyst diameter D5 in the parasite cyst information Info_5 of the parasite cyst image ImgE_5 is greater than the first diameter threshold 122 (i.e., the determination result is “Yes”). Therefore, the processor 130 determines that the parasite cyst interpretation result Rslt_5 is the Entamoeba coli cyst.

As shown in FIG. 7, with respect to the parasite cyst image ImgE_6, a parasite cyst contour C6 of the parasite cyst information Info_6 is approximately elliptical, so the processor 130 records the corresponding parasite cyst aspect ratio. Since a parasite cyst diameter corresponding to the parasite cyst image ImgE_6 is not recorded, the processor 130 determines in Step S021 that the parasite cyst interpretation result Rslt_6 is not the Entamoeba coli cyst (i.e., the determination result is “No”) and subsequently performs Step S023. In Step S023, the processor 130 determines that the parasite cyst aspect ratio in the parasite cyst information Info_6 of the parasite cyst image ImgE_6 is greater than the aspect ratio threshold 125 (i.e., the determination result is “Yes”). Therefore, the processor 130 determines that the parasite cyst interpretation result Rslt_6 is the Giardia lamblia cyst.

Therefore, the interpretation method 200 of the present disclosure can utilize the parasite cyst information Info_1-Info_N to quickly interpret and filter out Species 4 “Entamoeba coli cyst” (having an approximately circular contour and the parasite cyst diameter exceeding the first diameter threshold 122), and Species 6 “Giardia lamblia cyst” (having an approximately elliptical contour and the parasite cyst aspect ratio exceeding the aspect ratio threshold 125), from the parasite cyst images ImgE_1-ImgE_N. In addition, based on the parasite cyst information Info_1-Info_N, the processor 130 can also preliminarily identify Species 1 “Entamoeba histolytica cyst”, Species 2 “Entamoeba hartmanni cyst”, and Species 3 “Endolimax nana cyst” so as to enhance the accuracy of the subsequent object detection performed by the deep learning model 121 and reduce the training workload of the deep learning model 121 during the model training process. After filtering out Species 4 “Entamoeba coli cyst” and Species 6 “Giardia lamblia cyst”, the processor 130 can subsequently perform Step S03 and Step S04 to carry out the cross-comparison process 131 for the remaining parasite cyst images (excluding Species 4 and Species 6) having the same feature category so as to identify their parasite cyst species.

In some embodiments, the deep learning model 121 can be, but is not limited to, a Regions with Convolutional Neural Network (R-CNN) or a Mask Region-based Convolutional Neural Network (Mask R-CNN). Preferably, the deep learning model 121 of the present disclosure is the Mask R-CNN.

In Step S03, the deep learning model 121 respectively extracts the biological features BF_1-BF_N from the parasite cyst images ImgE_1-ImgE_N and classifies them. In detail, the feature categories can include a first category feature, a second category feature, and a third category feature. The first category feature represents that at least one biological feature of one of the parasite cyst images ImgE_1-ImgE_N has a karyosome chromatin and does not have a peripheral chromatin. The second category feature represents that the at least one biological feature of the one of the parasite cyst images ImgE_1-ImgE_N has both the karyosome chromatin and the peripheral chromatin. The third category feature represents that the at least one biological feature of the one of the parasite cyst images ImgE_1-ImgE_N has a nucleus located at an edge of the parasite cyst.

After classifying the first category feature, the second category feature, and the third category feature, the processor 130, in step S04, can preliminarily identify Species 1 “Entamoeba histolytica cyst”, Species 2 “Entamoeba hartmanni cyst”, Species 3 “Endolimax nana cyst”, Species 5 “Iodamoeba butschlii cyst”, and Species 7 “Blastocystis species cyst” based on these feature categories in combination with the parasite cyst information Info_1-Info_N.

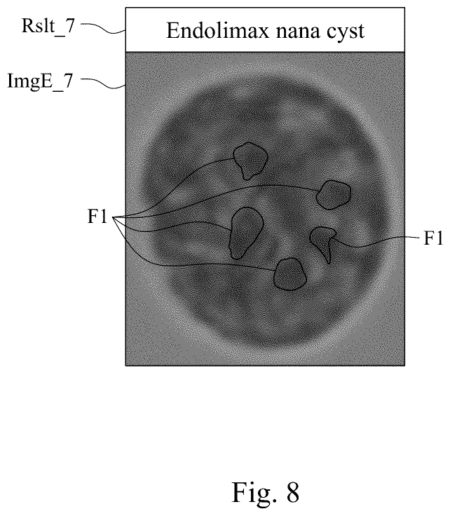

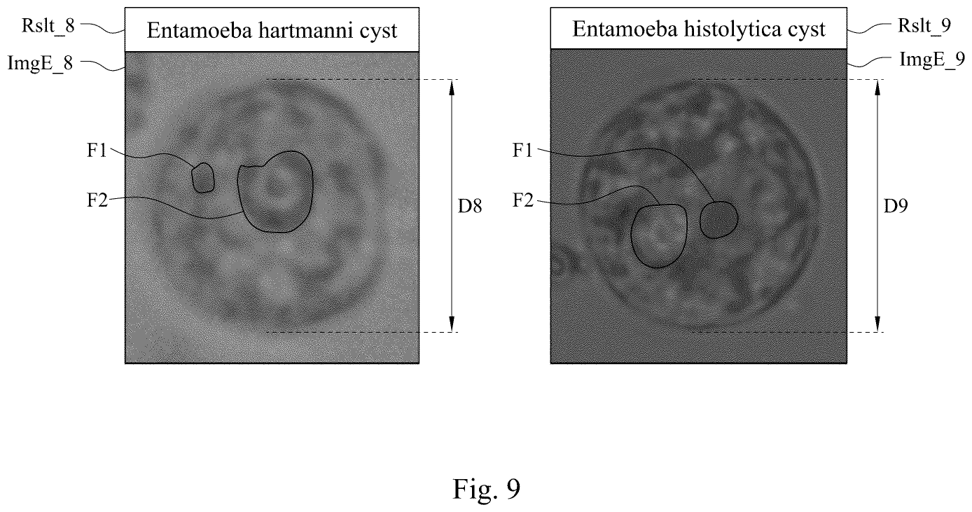

Please refer to FIGS. 8 and 9. FIG. 8 is a schematic diagram illustrating the parasite cyst image ImgE_7 of the Endolimax nana cyst according to an embodiment of the present disclosure. FIG. 9 is a schematic diagram illustrating the parasite cyst images ImgE_8, ImgE_9 of the Entamoeba hartmanni cyst and the Entamoeba histolytica cyst according to an embodiment of the present disclosure.

In some embodiments, Step S04 can include determining, by the processor 130, that a parasite cyst interpretation result of one of the parasite cyst images ImgE_1-ImgE_N having “only” the first category feature is the Endolimax nana cyst. As shown in FIG. 8, since the parasite cyst image ImgE_7 is labeled with a plurality of first type features F1 only, the processor 130 determines that the parasite cyst interpretation result Rslt_7 of the parasite cyst image ImgE_7 is Species 3 “Endolimax nana cyst”.

In some embodiments, Step S04 can further include determining, by the processor 130, that the parasite cyst interpretation result of the one of the parasite cyst images ImgE_1-ImgE_N having the first category feature is the Entamoeba histolytica cyst, the Entamoeba hartmanni cyst, or the Endolimax nana cyst; and determining, by the processor 130, whether the one of the parasite cyst images ImgE_1-ImgE_N having the first category feature also has the second category feature to generate a determination result. When the determination result is “Yes”, the processor 130 determines that a parasite cyst interpretation result of the one of the parasite cyst images ImgE_1-ImgE_N having both the first category feature and the second category feature is Species 1 “Entamoeba histolytica cyst” or Species 2 “Entamoeba hartmanni cyst”. Conversely, when the determination result is “No”, the processor 130 determines that the parasite cyst interpretation result of the one of the parasite cyst images ImgE_1-ImgE_N having the first category feature but not the second category feature is Species 3 “Endolimax nana cyst”.

As shown in FIGS. 8 and 9, the processor 130, through the deep learning model 121, classifies and labels the first category features F1 in all of the parasite cyst images ImgE_7, ImgE_8, ImgE_9. Therefore, the processor 130 preliminarily determines that the parasite cyst interpretation results Rslt_7, Rslt_8, Rslt_9 of the parasite cyst images ImgE_7, ImgE_8, ImgE_9 are the Entamoeba histolytica cyst, the Entamoeba hartmanni cyst, or the Endolimax nana cyst.

Since the parasite cyst image ImgE_7 has only the first category feature F1 and does not have the second category feature F2, the processor 130 finally determines that the parasite cyst interpretation result Rslt_7 of the parasite cyst image ImgE_7 is Species 3 “Endolimax nana cyst”. Since the parasite cyst images ImgE_8, ImgE_9 are further classified and labeled with the second category feature F2, the processor 130 preliminarily determines that the parasite cyst interpretation results Rslt_8, Rslt_9 of the parasite cyst images ImgE_8, ImgE_9 having both the first category feature F1 and the second category feature F2 are Species 1 “Entamoeba histolytica cyst” or Species 2 “Entamoeba hartmanni cyst”.

In addition, the processor 130 reads the second diameter threshold 123 from the storage device 120 and determines whether each of parasite cyst diameters D8, D9 in the parasite cyst information Info_8, Info_9 of the parasite cyst images ImgE_8, ImgE_9 is greater than the second diameter threshold 123 to generate a determination result. When the determination result is “Yes”, the processor 130 determines that the parasite cyst interpretation result of the one of the parasite cyst images corresponding to the parasite cyst diameter (which is greater than the second diameter threshold 123) is the Entamoeba histolytica cyst. Conversely, when the determination result is “No”, the processor 130 determines that the parasite cyst interpretation result of the one of the parasite cyst images corresponding to the parasite cyst diameter (which is less than the second diameter threshold 123) is the Entamoeba hartmanni cyst. In some embodiments, the second diameter threshold 123 can be, but is not limited to, 12 μm. Based on the fact that the parasite cyst diameter D9 of the parasite cyst image ImgE_9 is greater than the second diameter threshold 123, the processor 130 finally determines that the parasite cyst interpretation result Rslt_9 of the parasite cyst image ImgE_9 is Species 1 “Entamoeba histolytica cyst”. Based on the fact that the parasite cyst diameter D8 of the parasite cyst image ImgE_8 is less than the second diameter threshold 123, the processor 130 finally determines that the parasite cyst interpretation result Rslt_8 of the parasite cyst image ImgE_8 is Species 2 “Entamoeba hartmanni cyst”.

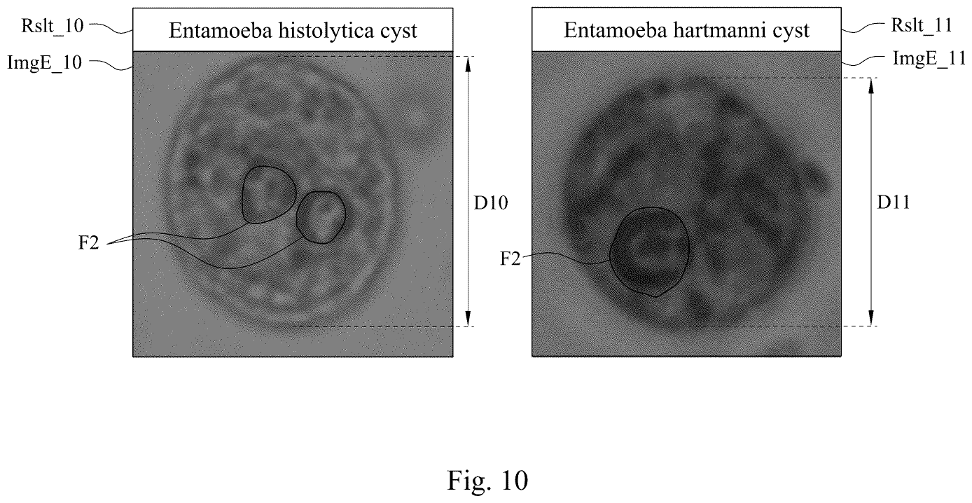

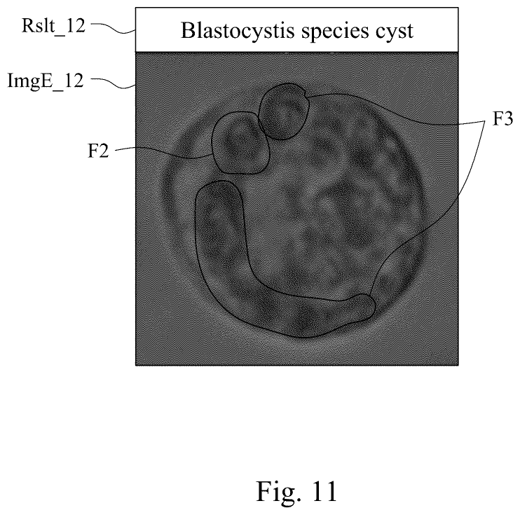

Please refer to FIGS. 10 and 11. FIG. 10 is a schematic diagram illustrating the parasite cyst images ImgE_10, ImgE_11 of the Entamoeba histolytica cyst and the Entamoeba hartmanni cyst according to another embodiment of the present disclosure. FIG. 11 is a schematic diagram illustrating the parasite cyst image ImgE_12 of the Blastocystis species cyst according to an embodiment of the present disclosure.

In some embodiments, Step S04 can include determining, by the processor 130, that the parasite cyst interpretation result of one of the parasite cyst images ImgE_1-ImgE_N having “only” the second category feature is the Entamoeba histolytica cyst or the Entamoeba hartmanni cyst; and determining, by the processor 130, whether a parasite cyst diameter of the parasite cyst information is greater than the second diameter threshold 123 to generate a determination result. When the determination result is “Yes”, the processor 130 determines that the parasite cyst interpretation result of the one of the parasite cyst images ImgE_1-ImgE_N corresponding to the parasite cyst diameter is Species 1 “Entamoeba histolytica cyst”. Conversely, when the determination result is “No”, the processor 130 determines that the parasite cyst interpretation result of the one of the parasite cyst images ImgE_1-ImgE_N corresponding to the parasite cyst diameter is Species 2 “Entamoeba hartmanni cyst”.

As shown in FIG. 10, since the parasite cyst image ImgE_10 is classified and labeled with two second category features F2 and the parasite cyst image ImgE_11 is classified and labeled with one second category feature F2, the processor 130 preliminarily determines that the parasite cyst interpretation results Rslt_10, Rslt_11 of the parasite cyst images ImgE_10, ImgE_11 are Species 1 “Entamoeba histolytica cyst” or Species 2 “Entamoeba hartmanni cyst”. Then, based on a parasite cyst diameter D10 of the parasite cyst image ImgE_10 exceeding the second diameter threshold 123 (i.e., the determination result “Yes”), the processor 130 finally determines that the parasite cyst interpretation result Rslt_10 of the parasite cyst image ImgE_10 is Species 1 “Entamoeba histolytica cyst”. Based on the parasite cyst diameter D11 of the parasite cyst image ImgE_11 being less than the second diameter threshold 123 (i.e., the determination result “No”), the processor 130 finally determines that the parasite cyst interpretation result Rslt_11 of the parasite cyst image ImgE_11 is Species 2 “Entamoeba hartmanni cyst”.

In some embodiments, Step S04 can include determining, by the processor 130, that the parasite cyst interpretation result of one of the parasite cyst images ImgE_1-ImgE_N having the second category feature is the Entamoeba histolytica cyst, the Entamoeba hartmanni cyst, or the Blastocystis species cyst; and determining, by the processor 130, whether the one of the parasite cyst images ImgE_1-ImgE_N having the second category feature also has the third category feature to generate a determination result. When the determination result is “Yes”, the processor 130 determines that the parasite cyst interpretation result of the one of the parasite cyst images having both the second category feature and the third category feature is Species 7 “Blastocystis species cyst”. Conversely, when the determination result is “No”, the processor 130 determines that the parasite cyst interpretation result of the one of the parasite cyst images ImgE_1-ImgE_N having the second category feature but not the third category feature is Species 1 “Entamoeba histolytica cyst” or Species 2 “Entamoeba hartmanni cyst”.

As shown in FIGS. 10 and 11, the processor 130, through the deep learning model 121, classifies and labels the second category feature F2 in the parasite cyst images ImgE_10, ImgE_11, ImgE_12. Accordingly, the processor 130 preliminarily determines that the parasite cyst interpretation results Rslt_10, Rslt_11, Rslt_12 of the parasite cyst images ImgE_10, ImgE_11, ImgE_12 are Species 1 “Entamoeba histolytica cyst”, Species 2 “Entamoeba hartmanni cyst”, or Species 7 “Blastocystis species cyst”.

Based on the parasite cyst images ImgE_10, ImgE_11 having only the second category feature F2 and not the third category feature F3, the processor 130 preliminarily determines that the parasite cyst interpretation results Rslt_10, Rslt_11 of the parasite cyst images ImgE_10, ImgE_11 are Species 1 “Entamoeba histolytica cyst” or Species 2 “Entamoeba hartmanni cyst”. Then, the processor 130 compares the parasite cyst diameters D10, D11 with the second diameter threshold 123 to finally determine that the parasite cyst interpretation result Rslt_10 of the parasite cyst image ImgE_10 is Species 1 “Entamoeba histolytica cyst”, and the parasite cyst interpretation result Rslt_11 of the parasite cyst image ImgE_11 is Species 2 “Entamoeba hartmanni cyst”. Furthermore, based on the parasite cyst image ImgE_12 being further classified and labeled with the third category feature F3, the processor 130 finally determines that the parasite cyst interpretation result Rslt_12 of the parasite cyst image ImgE_12 having both the second category feature F2 and the third category feature F3 is Species 7 “Blastocystis species cyst”.

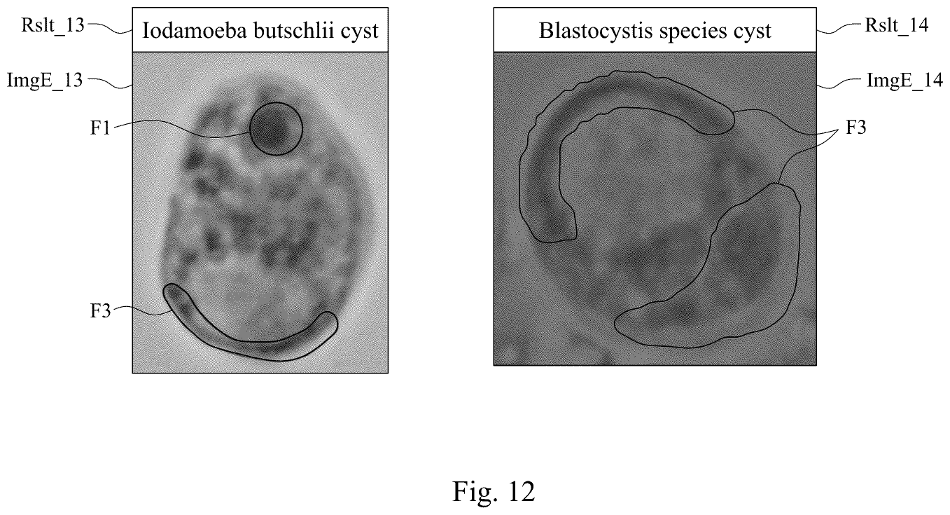

Please refer to FIG. 12. FIG. 12 is a schematic diagram illustrating parasite cyst images ImgE_13, ImgE_14 of the Iodamoeba butschlii cyst and the Blastocystis species cyst according to an embodiment of the present disclosure.

In some embodiments, Step S04 can include determining, by the processor 130, that the parasite cyst interpretation result of one of the parasite cyst images ImgE_1-ImgE_N having the third category feature is the Iodamoeba butschlii cyst or the Blastocystis species cyst; and determining, by the processor 130, whether the one of the parasite cyst images ImgE_1-ImgE_N having the third category feature also has the first category feature, and simultaneously determining whether a size of the first category feature is greater than the third diameter threshold 124 to generate a determination result. When the determination result is “Yes”, the processor 130 determines that the parasite cyst interpretation result of the one of the parasite cyst images ImgE_1-ImgE_N having both the first category feature and the third category feature, and in which the size of the first category feature is greater than the third diameter threshold 124, is Species 5 “Iodamoeba butschlii cyst”. Conversely, when the determination result is “No”, the processor 130 determines that the parasite cyst interpretation result of the one of the parasite cyst images ImgE_1-ImgE_N having both the first category feature and the third category feature, and in which the size of the first category feature is less than the third diameter threshold 124, is Species 7 “Blastocystis species cyst”. In addition, when the determination result is “No”, the processor 130 determines that the parasite cyst interpretation result of the one of the parasite cyst images ImgE_1-ImgE_N having the third category feature but not the first category feature is Species 7 “Blastocystis species cyst”. It should first be noted that the third diameter threshold 124 is primarily configured to prevent minor impurities in parasite cyst images of actual Blastocystis species cysts from being misidentified as the first category feature, which would otherwise result in misidentifying the actual Blastocystis species cysts as the Iodamoeba butschlii cyst. The processor 130 can therefore compare the size of the first category feature with the third diameter threshold 124 to distinguish Iodamoeba butschlii cysts from Blastocystis species cysts.

As shown in FIG. 12, the processor 130, through the deep learning model 121, classifies and labels the third category feature F3 in the parasite cyst images ImgE_13, ImgE_14. Accordingly, the processor 130 preliminarily determines that the parasite cyst interpretation results Rslt_13, Rslt_14 of the parasite cyst images ImgE_13, ImgE_14 are Species 5 “Iodamoeba butschlii cyst” or Species 7 “Blastocystis species cyst”.

In some embodiments, the third diameter threshold 124 can be, but is not limited to, 2 μm. Based on the parasite cyst image ImgE_13 being further classified and labeled with the first category feature F1 and the size of the first category feature F1 being greater than the third diameter threshold 124, the processor 130 finally determines that the parasite cyst interpretation result Rslt_13 of the parasite cyst image ImgE_13 having both the first category feature F1 and the third category feature F3 is Species 5 “Iodamoeba butschlii cyst”. Then, based on the parasite cyst image ImgE_14 having only the third category feature F3 and not the first category feature F1, the processor 130 finally determines that the parasite cyst interpretation result Rslt_14 of the parasite cyst image ImgE_14 is Species 7 “Blastocystis species cyst”.

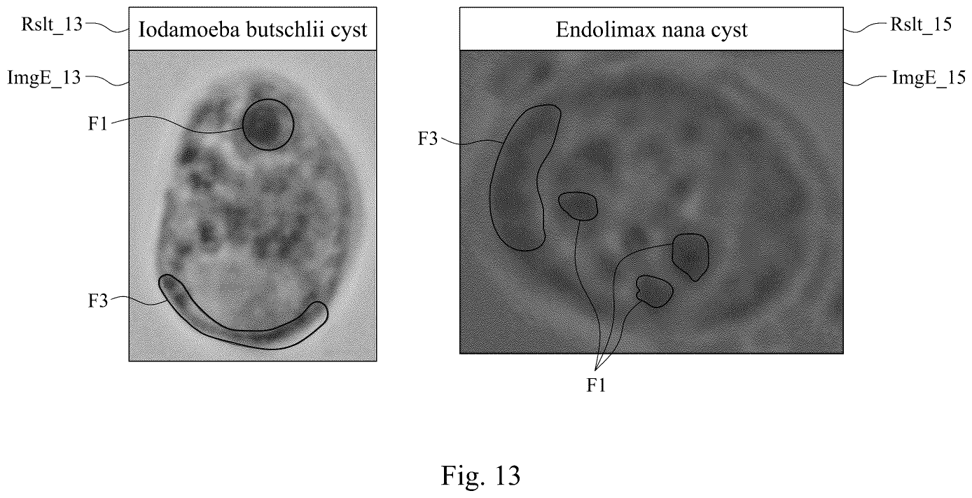

Please refer to FIG. 13. FIG. 13 is a schematic diagram illustrating parasite cyst images ImgE_13, ImgE_15 of the Iodamoeba butschlii cyst and the Endolimax nana cyst according to an embodiment of the present disclosure.

In some embodiments, Step S04 can include determining, by the processor 130, that the parasite cyst interpretation result of one of the parasite cyst images ImgE_1-ImgE_N having both the first category feature and the third category feature is the Endolimax nana cyst, the Iodamoeba Butschlii cyst, or the Blastocystis species cyst; and determining, by the processor 130, whether a number of the at least one biological feature of the one of the parasite cyst images ImgE_1-ImgE_N that is the first category feature is greater than 1 to generate a determination result. When the determination result is “Yes”, the processor 130 determines that the parasite cyst interpretation result of the one of the parasite cyst images ImgE_1-ImgE_N corresponding to the number is Species 3 “Endolimax nana cyst”. Conversely, when the determination result is “No”, the processor 130 determines that the parasite cyst interpretation result of the one of the parasite cyst images ImgE_1-ImgE_N corresponding to the number is Species 5 “Iodamoeba butschlii cyst” or Species 7 “Blastocystis species cyst”, and subsequently determines whether a size of the first category feature of the one of the parasite cyst images ImgE_1-ImgE_N corresponding to the number is greater than the third diameter threshold 124 to generate another determination result. When the another determination result is “Yes”, the processor 130 determines that the parasite cyst interpretation result of the one of the parasite cyst images ImgE_1-ImgE_N corresponding to the number is Species 5 “Iodamoeba butschlii cyst”. When the another determination result is “No”, the processor 130 determines that the parasite cyst interpretation result of the one of the parasite cyst images ImgE_1-ImgE_N corresponding to the number is Species 7 “Blastocystis species cyst”.

As shown in FIG. 13, the processor 130, through the deep learning model 121, classifies and labels the first category feature F1 and the third category feature F3 in the parasite cyst images ImgE_13, ImgE_15. Accordingly, the processor 130 preliminarily determines that the parasite cyst interpretation results Rslt_13, Rslt_15 of the parasite cyst images ImgE_13, ImgE_15 are Species 3 “Endolimax nana cyst”, Species 5 “Iodamoeba butschlii cyst”, or Species 7 “Blastocystis species cyst”. Furthermore, the number of the first category feature F1 in the parasite cyst image ImgE_13 is 1 and the size of the first category feature F1 is greater than the third diameter threshold 124, whereas the number of the first category features F1 in the parasite cyst image ImgE_15 is 3. Accordingly, the processor 130 finally determines that the parasite cyst interpretation result Rslt_15 of the parasite cyst image ImgE_15 having more than one first category feature F1 is Species 3 “Endolimax nana cyst”, and that the parasite cyst interpretation result Rslt_13 of the parasite cyst image ImgE_13 having only one first category feature F1 with the size greater than the third diameter threshold 124 is Species 5 “Iodamoeba butschlii cyst”.

As can be seen, different species of parasite cysts can also exhibit the same biological features. Preliminary recognition using only the deep learning model 121 for object detection cannot achieve optimal accuracy. Therefore, the interpretation method 200 of the present disclosure not only uses the first category feature F1, the second category feature F2, and the third category feature F3 obtained from the deep learning model 121 as the sole basis for determining parasite cyst species, but also incorporates the number of category features and the parasite cyst information Info_1-Info_N to perform the cross-comparison process 131 among the parasite cyst images ImgE_1-ImgE_N having the same feature category, thereby achieving optimal accuracy for parasite cyst recognition.

Please refer to Table 1, which provides an example of the accuracy for each species of parasite cyst obtained after interpretation of 823 parasite cyst images (i.e., the parasite cyst information Info_1-Info_N). However, the present disclosure is not limited thereto.

TABLE 1

| serial | | number of | |
|---|---|---|---|
| number | species of parasite cyst | interpretations | accuracy |
| 1 | Entamoeba histolytica cyst | 79 | 91.14% |
| 2 | Entamoeba hartmanni cyst | 65 | 84.62% |
| 3 | Endolimax nana cyst | 192 | 84.38% |
| 4 | Entamoeba coli cyst | 30 | 80.00% |
| 5 | Iodamoeba butschlii cyst | 8 | 80.00% |
| 6 | Giardia lamblia cyst | 122 | 80.33% |
| 7 | Blastocystis species cyst | 327 | 83.49% |

As shown in Table 1, the overall accuracy reaches 83.42%, while the interpretation process takes only about 300 seconds. Accordingly, the interpretation system 100 and the interpretation method 200 of the present disclosure exhibit excellent performance in parasite cyst recognition. In particular, for the interpretation of Species 1 “Entamoeba histolytica cyst”, the accuracy reaches as high as 91.14%. It is noteworthy that amoebic dysentery caused by Entamoeba histolytica is classified as Category II infectious disease. Therefore, the interpretation system 100 and the interpretation method 200 of the present disclosure can provide medical technician with a rapid and accurate auxiliary diagnostic tool.

In summary, the interpretation method and the interpretation system for the parasite cyst of the present disclosure offer the following advantages: (1) utilizing the deep learning model to automatically identify biological features of different parasite cyst images and perform cross-comparison between the biological features (and their corresponding quantities) and parasite cyst information to generate parasite cyst interpretation results, thereby shortening the manual slide-reading time, reducing labor costs, and improving detection rate and accuracy; (2) assisting medical institutions in the early detection and control of parasite infection outbreaks, provide precise data analysis and reporting, and support public health decision-making; (3) supplying medical research institutions with high-quality data and analytical tools to support research activities, particularly those involving basic and clinical studies of parasitic infections, thereby improving research accuracy and efficiency and promoting academic advancement in the field of parasitology; and (4) the interpretation system is easy to operate, requires no additional learning cost, and stores every interpreted image for future review, so that the interpretation system can be applied to various parasite cyst interpretation and diagnostic tasks.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An interpretation method for a parasite cyst, comprising a plurality of steps of:
photographing, by an electronic equipment, a parasite specimen to generate an electronic image;
cutting, by a processor, the electronic image to generate a plurality of parasite cyst images, and obtaining a parasite cyst information on each of the parasite cyst images;
extracting, by the processor, at least one biological feature from each of the parasite cyst images by a deep learning model, and classifying the at least one biological feature into at least one of a plurality of feature categories; and
performing, by the processor, a cross-comparison on the parasite cyst images having at least one same feature category according to the parasite cyst information and the feature categories, thereby generating a parasite cyst interpretation result for each of the parasite cyst images, wherein the feature categories comprise the at least one same feature category.

2. The interpretation method for the parasite cyst of claim 1, wherein the step of obtaining the parasite cyst information on each of the parasite cyst images comprises:
determining, by the processor, whether a parasite cyst diameter of the parasite cyst information is greater than a first diameter threshold to generate a determination result;
wherein, when the determination result is yes, the processor determines that the parasite cyst interpretation result of one of the parasite cyst images corresponding to the parasite cyst diameter is an Entamoeba coli cyst;
wherein, when the determination result is no, the processor determines that the parasite cyst interpretation result of the one of the parasite cyst images corresponding to the parasite cyst diameter is not the Entamoeba coli cyst.

3. The interpretation method for the parasite cyst of claim 1, wherein the step of obtaining the parasite cyst information on each of the parasite cyst images comprises:
determining, by the processor, whether a parasite cyst aspect ratio of the parasite cyst information is greater than an aspect ratio threshold to generate a determination result;
wherein, when the determination result is yes, the processor determines that the parasite cyst interpretation result of one of the parasite cyst images corresponding to the parasite cyst aspect ratio is a Giardia lamblia cyst;
wherein, when the determination result is no, the processor determines that the parasite cyst interpretation result of the one of the parasite cyst images corresponding to the parasite cyst aspect ratio is not the Giardia lamblia cyst.

4. The interpretation method for the parasite cyst of claim 1, wherein,
the deep learning model is a Mask Region-based Convolutional Neural Network (Mask R-CNN), and the feature categories comprise a first category feature, a second category feature, and a third category feature;
the first category feature represents that the at least one biological feature of one of the parasite cyst images has a karyosome chromatin and does not have a peripheral chromatin;
the second category feature represents that the at least one biological feature of the one of the parasite cyst images has both the karyosome chromatin and the peripheral chromatin; and
the third category feature represents that the at least one biological feature of the one of the parasite cyst images has a nucleus located at an edge of the parasite cyst.

5. The interpretation method for the parasite cyst of claim 4, wherein the step of generating the parasite cyst interpretation result for each of the parasite cyst images comprises:
determining, by the processor, that the parasite cyst interpretation result of the one of the parasite cyst images having only the first category feature is an Endolimax nana cyst.

6. The interpretation method for the parasite cyst of claim 4, wherein the step of generating the parasite cyst interpretation result for each of the parasite cyst images comprises:
determining, by the processor, that the parasite cyst interpretation result of the one of the parasite cyst images having the first category feature is an Entamoeba histolytica cyst, an Entamoeba hartmanni cyst, or an Endolimax nana cyst; and
determining, by the processor, whether the one of the parasite cyst images having the first category feature also has the second category feature to generate a determination result;
wherein, when the determination result is yes, the processor determines that the parasite cyst interpretation result of the one of the parasite cyst images having both the first category feature and the second category feature is the Entamoeba histolytica cyst or the Entamoeba hartmanni cyst;
wherein, when the determination result is no, the processor determines that the parasite cyst interpretation result of the one of the parasite cyst images having the first category feature but not the second category feature is the Endolimax nana cyst.

7. The interpretation method for the parasite cyst of claim 4, wherein the step of generating the parasite cyst interpretation result for each of the parasite cyst images comprises:
determining, by the processor, that the parasite cyst interpretation result of the one of the parasite cyst images having only the second category feature is an Entamoeba histolytica cyst or an Entamoeba hartmanni cyst; and
determining, by the processor, whether a parasite cyst diameter of the parasite cyst information is greater than a second diameter threshold to generate a determination result;
wherein, when the determination result is yes, the processor determines that the parasite cyst interpretation result of the one of the parasite cyst images corresponding to the parasite cyst diameter is the Entamoeba histolytica cyst;
wherein, when the determination result is no, the processor determines that the parasite cyst interpretation result of the one of the parasite cyst images corresponding to the parasite cyst diameter is the Entamoeba hartmanni cyst.

8. The interpretation method for the parasite cyst of claim 4, wherein the step of generating the parasite cyst interpretation result for each of the parasite cyst images comprises:
determining, by the processor, that the parasite cyst interpretation result of the one of the parasite cyst images having the second category feature is an Entamoeba histolytica cyst, an Entamoeba hartmanni cyst, or a Blastocystis species cyst; and
determining, by the processor, whether the one of the parasite cyst images having the second category feature also has the third category feature to generate a determination result;
wherein, when the determination result is yes, the processor determines that the parasite cyst interpretation result of the one of the parasite cyst images having both the second category feature and the third category feature is the Blastocystis species cyst;
wherein, when the determination result is no, the processor determines that the parasite cyst interpretation result of the one of the parasite cyst images having the second category feature but not the third category feature is the Entamoeba histolytica cyst or the Entamoeba hartmanni cyst.

9. The interpretation method for the parasite cyst of claim 4, wherein the step of generating the parasite cyst interpretation result for each of the parasite cyst images comprises:
determining, by the processor, that the parasite cyst interpretation result of the one of the parasite cyst images having the third category feature is an Iodamoeba butschlii cyst or a Blastocystis species cyst; and
determining, by the processor, whether the one of the parasite cyst images having the third category feature also has the first category feature, and simultaneously determining whether a size of the first category feature is greater than a third diameter threshold to generate a determination result;
wherein, when the determination result is yes, the processor determines that the parasite cyst interpretation result of the one of the parasite cyst images having both the first category feature and the third category feature, and in which the size of the first category feature is greater than the third diameter threshold, is the Iodamoeba butschlii cyst;
wherein, when the determination result is no, the processor determines that the parasite cyst interpretation result of the one of the parasite cyst images having both the first category feature and the third category feature, and in which the size of the first category feature is less than the third diameter threshold, is the Blastocystis species cyst;
wherein, when the determination result is no, the processor determines that the parasite cyst interpretation result of the one of the parasite cyst images having the third category feature but not the first category feature is the Blastocystis species cyst.

10. The interpretation method for the parasite cyst of claim 4, wherein the step of generating the parasite cyst interpretation result for each of the parasite cyst images comprises:
determining, by the processor, that the parasite cyst interpretation result of the one of the parasite cyst images having both the first category feature and the third category feature is an Endolimax nana cyst, an Iodamoeba Butschlii cyst, or a Blastocystis species cyst; and
determining, by the processor, whether a number of the at least one biological feature of the one of the parasite cyst images that is the first category feature is greater than 1 to generate a determination result;
wherein, when the determination result is yes, the processor determines that the parasite cyst interpretation result of the one of the parasite cyst images corresponding to the number is the Endolimax nana cyst;
wherein, when the determination result is no, the processor determines that the parasite cyst interpretation result of the one of the parasite cyst images corresponding to the number is the Iodamoeba Butschlii cyst or the Blastocystis species cyst, and subsequently determines whether a size of the first category feature of the one of the parasite cyst images corresponding to the number is greater than a third diameter threshold to generate another determination result, wherein when the another determination result is yes, the processor determines that the parasite cyst interpretation result of the one of the parasite cyst images corresponding to the number is the Iodamoeba Butschlii cyst, wherein when the another determination result is no, the processor determines that the parasite cyst interpretation result of the one of the parasite cyst images corresponding to the number is the Blastocystis species cyst.

11. An interpretation system for a parasite cyst, comprising:
an electronic equipment, configured to photograph a parasite specimen to generate an electronic image;
a storage device, connected to the electronic equipment and storing the electronic image and a deep learning model; and
a processor, connected to the storage device and configured to perform following steps:
cutting, by the processor, the electronic image to generate a plurality of parasite cyst images, and obtaining a parasite cyst information on each of the parasite cyst images;
extracting, by the processor, at least one biological feature from each of the parasite cyst images by the deep learning model, and classifying the at least one biological feature into at least one of a plurality of feature categories; and
performing, by the processor, a cross-comparison on the parasite cyst images having at least one same feature category according to the parasite cyst information and the feature categories, thereby generating a parasite cyst interpretation result for each of the parasite cyst images, wherein the feature categories comprise the at least one same feature category.

12. The interpretation system for the parasite cyst of claim 11, wherein,
the processor determines whether a parasite cyst diameter of the parasite cyst information is greater than a first diameter threshold to generate a determination result;
wherein, when the determination result is yes, the processor determines that the parasite cyst interpretation result of one of the parasite cyst images corresponding to the parasite cyst diameter is an Entamoeba coli cyst;
wherein, when the determination result is no, the processor determines that the parasite cyst interpretation result of the one of the parasite cyst images corresponding to the parasite cyst diameter is not the Entamoeba coli cyst.

13. The interpretation system for the parasite cyst of claim 11, wherein,
the processor determines whether a parasite cyst aspect ratio of the parasite cyst information is greater than an aspect ratio threshold to generate a determination result;
wherein, when the determination result is yes, the processor determines that the parasite cyst interpretation result of one of the parasite cyst images corresponding to the parasite cyst aspect ratio is a Giardia lamblia cyst;
wherein, when the determination result is no, the processor determines that the parasite cyst interpretation result of the one of the parasite cyst images corresponding to the parasite cyst aspect ratio is not the Giardia lamblia cyst.

14. The interpretation system for the parasite cyst of claim 11, wherein,
the deep learning model is a Mask Region-based Convolutional Neural Network (Mask R-CNN), and the feature categories comprise a first category feature, a second category feature, and a third category feature;
the first category feature represents that the at least one biological feature of one of the parasite cyst images has a karyosome chromatin and does not have a peripheral chromatin;
the second category feature represents that the at least one biological feature of the one of the parasite cyst images has both the karyosome chromatin and the peripheral chromatin; and
the third category feature represents that the at least one biological feature of the one of the parasite cyst images has a nucleus located at an edge of the parasite cyst.

15. The interpretation system for the parasite cyst of claim 14, wherein the processor determines that the parasite cyst interpretation result of the one of the parasite cyst images having only the first category feature is an Endolimax nana cyst.

16. The interpretation system for the parasite cyst of claim 14, wherein,
the processor determines that the parasite cyst interpretation result of the one of the parasite cyst images having the first category feature is an Entamoeba histolytica cyst, an Entamoeba hartmanni cyst, or an Endolimax nana cyst; and
the processor determines whether the one of the parasite cyst images having the first category feature also has the second category feature to generate a determination result;
wherein, when the determination result is yes, the processor determines that the parasite cyst interpretation result of the one of the parasite cyst images having both the first category feature and the second category feature is the Entamoeba histolytica cyst or the Entamoeba hartmanni cyst;
wherein, when the determination result is no, the processor determines that the parasite cyst interpretation result of the one of the parasite cyst images having the first category feature but not the second category feature is the Endolimax nana cyst.

17. The interpretation system for the parasite cyst of claim 14, wherein,
the processor determines that the parasite cyst interpretation result of the one of the parasite cyst images having only the second category feature is an Entamoeba histolytica cyst or an Entamoeba hartmanni cyst; and
the processor determines whether a parasite cyst diameter of the parasite cyst information is greater than a second diameter threshold to generate a determination result;
wherein, when the determination result is yes, the processor determines that the parasite cyst interpretation result of the one of the parasite cyst images corresponding to the parasite cyst diameter is the Entamoeba histolytica cyst;
wherein, when the determination result is no, the processor determines that the parasite cyst interpretation result of the one of the parasite cyst images corresponding to the parasite cyst diameter is the Entamoeba hartmanni cyst.

18. The interpretation system for the parasite cyst of claim 14, wherein,
the processor determines that the parasite cyst interpretation result of the one of the parasite cyst images having the second category feature is an Entamoeba histolytica cyst, an Entamoeba hartmanni cyst, or a Blastocystis species cyst; and
the processor determines whether the one of the parasite cyst images having the second category feature also has the third category feature to generate a determination result;
wherein, when the determination result is yes, the processor determines that the parasite cyst interpretation result of the one of the parasite cyst images having both the second category feature and the third category feature is the Blastocystis species cyst;
wherein, when the determination result is no, the processor determines that the parasite cyst interpretation result of the one of the parasite cyst images having the second category feature but not the third category feature is the Entamoeba histolytica cyst or the Entamoeba hartmanni cyst.

19. The interpretation system for the parasite cyst of claim 14, wherein the step of generating the parasite cyst interpretation result for each of the parasite cyst images comprises:
the processor determines that the parasite cyst interpretation result of the one of the parasite cyst images having the third category feature is an Iodamoeba butschlii cyst or a Blastocystis species cyst; and
the processor determines whether the one of the parasite cyst images having the third category feature also has the first category feature, and simultaneously determining whether a size of the first category feature is greater than a third diameter threshold to generate a determination result;
wherein, when the determination result is yes, the processor determines that the parasite cyst interpretation result of the one of the parasite cyst images having both the first category feature and the third category feature, and in which the size of the first category feature is greater than the third diameter threshold, is the Iodamoeba butschlii cyst;
wherein, when the determination result is no, the processor determines that the parasite cyst interpretation result of the one of the parasite cyst images having both the first category feature and the third category feature, and in which the size of the first category feature is less than the third diameter threshold, is the Blastocystis species cyst;
wherein, when the determination result is no, the processor determines that the parasite cyst interpretation result of the one of the parasite cyst images having the third category feature but not the first category feature is the Blastocystis species cyst.

20. The interpretation system for the parasite cyst of claim 14, wherein,
the processor determines that the parasite cyst interpretation result of the one of the parasite cyst images having both the first category feature and the third category feature is an Endolimax nana cyst, an Iodamoeba Butschlii cyst, or a Blastocystis species cyst; and
the processor determines whether a number of the at least one biological feature of the one of the parasite cyst images that is the first category feature is greater than 1 to generate a determination result;
wherein, when the determination result is yes, the processor determines that the parasite cyst interpretation result of the one of the parasite cyst images corresponding to the number is the Endolimax nana cyst;
wherein, when the determination result is no, the processor determines that the parasite cyst interpretation result of the one of the parasite cyst images corresponding to the number is the Iodamoeba Butschlii cyst or the Blastocystis species cyst, and subsequently determines whether a size of the first category feature of the one of the parasite cyst images corresponding to the number is greater than a third diameter threshold to generate another determination result, wherein when the another determination result is yes, the processor determines that the parasite cyst interpretation result of the one of the parasite cyst images corresponding to the number is the Iodamoeba Butschlii cyst, wherein when the another determination result is no, the processor determines that the parasite cyst interpretation result of the one of the parasite cyst images corresponding to the number is the Blastocystis species cyst.
